(19) United States
(12) Patent Application Publication
(10) Pub. No.: US 2026/0291394 A1
(43) Pub. Date: Sep. 24, 2026

(54) FLYBACK CONVERTER WITH IMPROVED LIGHT LOAD EFFICIENCY

(71) Applicant: Apple Inc., Cupertino, CA (US)

(72) Inventors: Prudhvi Mohan Maddineni, Milpitas, CA (US); Vijay G. Phadke, San Jose, CA (US); Liang Zhou, Sunnyvale, CA (US)

(21) Appl. No.: 19/082,656

(22) Filed: Mar. 18, 2025

(51) Int. Cl. H02M 3/335; H02M 1/34

(52) U.S. Cl. CPC H02M 3/3353; H02M 1/34

(57) ABSTRACT

Operating a plurality of switching devices of a flyback converter by control circuitry of the flyback converter can include operating a main switch at a fixed frequency to alternately store energy in a flyback transformer when the main switch is turned on and deliver energy from the flyback transformer to an output when the main switch is turned off; operating a voltage clamp switch complementarily to the main switch to clamp a voltage across a primary winding of the flyback transformer while the flyback converter is delivering energy to the output; and operating a reverse current switch to recover leakage energy in the flyback converter by turning on the reverse current switch while the voltage clamp switch is turned on and after energy stored in the flyback transformer is delivered to the output and turning off the reverse current switch with turning off with the voltage clamp switch.

### BACKGROUND

Flyback converters are a type of switching converter that can be used in a wide variety of applications. In some application, it may be desirable to provide a “clamp” circuit on the primary/input side of the flyback converter to recover energy that would otherwise be lost as a result of switching operation of the flyback converter. Embodiments of such clamped flyback converters include those using series-parallel mode active clamps as described in Applicant’s U.S. Patents 9,774,270 and 9,923,472.

### SUMMARY

Under certain operating conditions, at least some embodiments of prior art series-parallel active clamped flyback converters can experience decreased operating efficiency. It may therefore be desirable to provide enhanced circuits and control strategies to overcome these issues.

A flyback converter can include flyback converter circuitry including a flyback transformer having a primary winding coupled to a secondary winding and a main switch that alternately turns on to store energy from an input coupled to the primary winding in the flyback transformer and turns off deliver energy from the flyback transformer to an output coupled to the secondary winding; a voltage clamp circuit coupled to the flyback transformer, the voltage clamp circuit including a diode and a voltage clamp switch, wherein the voltage clamp switch operates complementarily to the main switch; a reverse current circuit coupled to the flyback transformer, the reverse current circuit including one or more snubber capacitors, one or more diodes, and a reverse current control switch, wherein the reverse current control switch operates in conjunction with the voltage clamp switch to recover leakage energy from the flyback converter circuitry; and control circuitry that provides drive signals to the main switch, voltage clamp switch, and reverse current control switch such that: the main switch operates at a fixed frequency and the control circuitry varies a duty cycle of the main switch to regulate an output voltage delivered to the output; the voltage clamp switch operates complementarily to the main switch; and the reverse current control switch turns on after energy stored in the flyback transformer is delivered to the output and a voltage of the primary winding is clamped by the voltage clamp circuit and turns off with the voltage clamp switch.

The voltage clamp circuit can be electrically coupled to the flyback transformer. The voltage clamp circuit can be electrically coupled in parallel with the primary winding. The one or more snubber capacitors can include a plurality of snubber capacitors; the one or more diodes can include a plurality of diodes; and the reverse current circuit can recover leakage energy from the flyback converter circuitry by charging the snubber capacitors in series and discharging the snubber capacitors in parallel. The reverse current circuit can include three or more snubber capacitors and six or more diodes.

The voltage clamp circuit can be magnetically coupled to the flyback transformer by an auxiliary winding to reduce current in the voltage clamp circuit. The one or more snubber capacitors can include a plurality of snubber capacitors; the one or more diodes include a plurality of diodes; and the reverse current circuit can recover leakage energy from the flyback converter circuitry by charging the snubber capacitors in series and discharging the snubber capacitors in parallel to recover leakage energy from the flyback converter circuitry. The reverse current circuit can include three or more snubber capacitors and six or more diodes.

A method of operating a plurality of switching devices of a flyback converter can be performed by control circuitry of the flyback converter and can include operating a main switch at a fixed frequency to alternately store energy in a flyback transformer when the main switch is turned on and deliver energy from the flyback transformer to an output when the main switch is turned off; operating a voltage clamp switch complementarily to the main switch to clamp a voltage across a primary winding of the flyback transformer while the flyback converter is delivering energy to the output; and operating a reverse current switch to recover leakage energy in the flyback converter by turning on the reverse current switch while the voltage clamp switch is turned on and after energy stored in the flyback transformer is delivered to the output and turning off the reverse current switch with turning off with the voltage clamp switch.

The method can further include varying a duty cycle of the main switch to regulate an output voltage delivered to the output. Turning on the reverse current switch can charge one or more snubber capacitors of a reverse current circuit, and turning off the reverse current switch can discharge the one or more snubber capacitors, thereby recovering leakage energy in the flyback converter. Turning on the reverse current switch can charge a plurality snubber capacitors of the reverse current circuit in series and turning off the reverse current switch can discharge the plurality snubber capacitors in parallel, thereby recovering leakage energy in the flyback converter.

A flyback converter can include flyback converter circuitry including a flyback transformer and a main switch; a voltage clamp circuit coupled to the flyback transformer and including a voltage clamp switch that operates complementarily to the main switch; a reverse current circuit coupled to the flyback transformer, the reverse current circuit including at least one snubber capacitor and a reverse current control switch, wherein the reverse current control switch operates in conjunction with the voltage clamp switch to recover leakage energy from the flyback converter circuitry; and control circuitry that provides drive signals to the main switch, voltage clamp switch, and reverse current control switch so as to: operate the main switch to alternately store energy in the flyback transformer when the main switch is turned on and deliver energy from the flyback transformer to an output when the main switch is turned off; operate the voltage clamp switch complementarily to the main switch to clamp a voltage across a primary winding of the flyback transformer while the flyback converter is delivering energy to the output; and operate the reverse current control switch to recover leakage energy in the flyback converter by turning on the reverse current control switch while the voltage clamp switch is turned on and after energy stored in the flyback transformer is delivered to the output and turning off the reverse current control switch with turning off with the voltage clamp switch.

The control circuitry can operate the main switch at a fixed frequency. The control circuitry can vary a duty cycle of the main switch to regulate an output voltage delivered to the output.

The voltage clamp circuit can be electrically coupled to the flyback transformer. The voltage clamp circuit can be coupled in parallel with the primary winding of the flyback transformer. The reverse current circuit can include a plurality of snubber capacitors and a plurality of diodes and can recover leakage energy from the flyback converter circuitry by charging the snubber capacitors in series and discharging the snubber capacitors in parallel.

The voltage clamp circuit can be magnetically coupled to the flyback transformer by an auxiliary winding to reduce current in the voltage clamp circuit. The reverse current circuit can include a plurality of snubber capacitors and a plurality of diodes and can recover leakage energy from the flyback converter circuitry by charging the snubber capacitors in series and discharging the snubber capacitors in parallel.

### BRIEF DESCRIPTION OF THE DRAWINGS

FIG. 1 illustrates a schematic diagram of a fixed-frequency, series-parallel active clamp flyback converter.

FIG. 2 illustrates various waveforms of a fixed-frequency, series-parallel active clamp flyback converter.

FIG. 3 illustrates a schematic diagram of a series-parallel active clamp flyback converter with an improved switching sequence.

FIG. 4 illustrates various waveforms of an improved series-parallel active clamp flyback converter.

FIG. 5 illustrates a schematic diagram of an alternative configuration of an improved series-parallel active clamp flyback converter with a voltage clamp connected to an auxiliary winding.

FIG. 6 illustrates a variation of a series-parallel mode active clamp flyback converter using additional snubber capacitors.

FIG. 7 illustrates an alternate embodiment of a series-parallel mode active clamp flyback converter using a high side auxiliary winding.

FIG. 8 illustrates an alternate embodiment of a series-parallel mode active clamp flyback converter using a reflected clamp.

### DETAILED DESCRIPTION

In the following description, for purposes of explanation, numerous specific details are set forth to provide a thorough understanding of the disclosed concepts. As part of this description, some of this disclosure’s drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

As noted above, flyback converters using series-parallel mode active clamps as described in Applicant’s U.S. Patent 9,774,270, which is hereby incorporated by reference in its entirety. Among other things, the ’270 patent describes a variable frequency, series-parallel active clamp flyback converter. While such a converter is capable of improved operating efficiency, there are some applications where variable frequency operation may not be preferred, such as power supplies for smartphones, tablet, computers, etc., where the switching frequency of the converter can potentially interfere with operation of the touch screen sensing systems. As one example, such interference could arise from common mode noise coupling of the power converter to the touch sensing circuitry. Applicant’s U.S. Patent 9,923,472, which is hereby incorporated by reference in its entirety, discloses, among other things, a fixed frequency, series-parallel active clamp flyback converter that can potentially overcome such issues. While the converters of the ’472 patent can overcome the above-described noise issues by operating outside a frequency band that is desired to be protected, certain operating conditions of such converters can lead to decreased efficiency. For example, efficiency reduction may occur when the converter is operating in deep discontinuous mode (e.g., at very low load currents) or when the reverse currents are high. Examples of such efficiency reductions and techniques for addressing them are described in greater detail below.

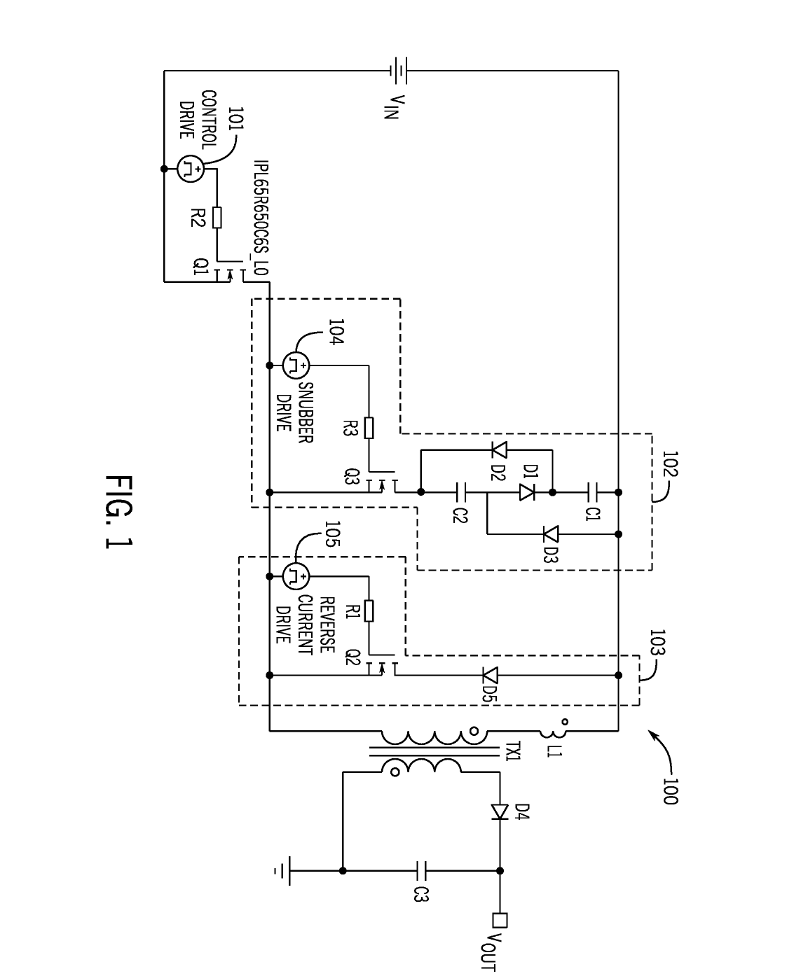

FIG. 1 illustrates a schematic diagram of a fixed-frequency, series-parallel active clamp flyback converter 100. Operational details of such a converter are described in the ’472 patent referenced above and thus are only briefly summarized here. Converter 100 includes a flyback transformer represented by transformer TX1 and its leakage inductance L1. Although illustrated separately in the schematic, the leakage inductance L1 can be a property of the flyback transformer and/or its primary coil and thus is not necessarily a discrete component. The flyback transformer may alternatively be thought of as a pair of mutually coupled inductors. The “primary” winding or coil of flyback transformer TX1 can be driven by main switch Q1. Main switch Q1 can be operated by control circuitry (not shown) that triggers control drive circuitry 101 to alternately turn main switch Q1 off and on. When main switch Q1 is turned on, current flows through the primary winding or coil of the flyback transformer, storing energy in the magnetic field thereof, e.g., in the leakage inductance L1. When main switch Q1 is turned off, this energy discharges via the secondary winding of the flyback transformer and diode D4 to power a load connected to the output voltage Vout.

Converter 100 can also include a snubber network (circuit) 102 and a reverse circulating network (circuit) 104. Snubber network can include snubber capacitors C1 and C2; diodes D1, D2, and D3; and snubber switch Q3. Snubber switch Q3 can be operated by the control circuitry (not shown) via snubber driver 104 so selectively charge and discharge the snubber capacitors to improve operating efficiency of the circuit. More specifically, the switch can be operated such that the snubber capacitors charge in series (via diode D1) and discharge in parallel (via diodes D2 and D3) as described in greater detail below and in further detail in the referenced ’472 patent. Reverse circulating network 103 can include reverse current drive switch Q2 and diode D5, which can be operated in conjunction with main switch Q1 and snubber switch Q3 to allow for fixed frequency operation as described in greater detail below and in further detail in the referenced ’472 patent. For purposes of the following description, the snubber circuit can also be considered as a “reverse current control” circuit, and the reverse circulating circuit can also be considered as a “voltage clamp” circuit. Thus, the snubber network (circuit) may also be described as a reverse current circuit, with snubber switch Q3 also referred to as reverse current switch Q3. Similarly, reverse circulating network (circuit) 104 may also be described as a voltage clamp circuit, with reverse circulating switch Q2 also referred to herein as voltage clamp switch Q2.

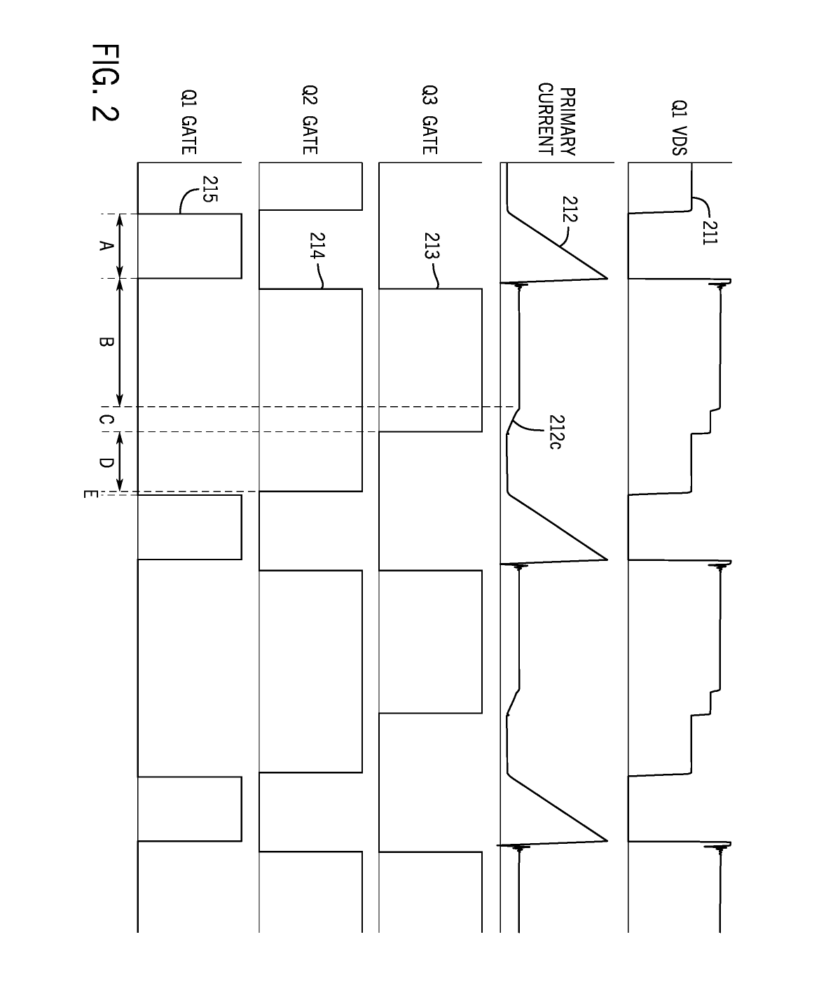

FIG. 2 illustrates various waveforms of a fixed-frequency, series-parallel active clamp flyback converter. Curve 211 depicts the drain to source voltage across main switch Q1. Curve 212 depicts the primary current flowing through the primary winding of the flyback transformer. Curve 213 depicts the gate drive signal provided to snubber/reverse current switch Q3. Curve 214 depicts the gate drive signal provided to reverse circulating/voltage clamp switch Q2. Curve 215 depicts the gate drive signal provided to main switch Q1.

When main switch Q1 is turned on, at the beginning of time interval A, primary current 212 begins ramping up linearly driven by the input voltage Vin. As can be seen in curve 211, there is zero voltage across main switch Q1 at this time, i.e., during time interval A. Likewise, reverse current switch Q3 and voltage clamp switch Q2 are also off during time interval A. When main switch Q1 is turned off, at the beginning of time interval B, both reverse current switch Q3 and voltage clamp switch Q2 can be turned on. That is, the main switch operates complementarily to the reverse current switch and the voltage clamp switch. This causes energy in the leakage inductance that has not coupled to secondary to be absorbed into the clamp by charging the snubber capacitors.

Time interval C can be referred to as the reverse current timer. During this time interval period the clamp discharges via reverse current switch Q3 and builds a reverse current in the transformer. This reverse current should be sufficient to recycle the leakage energy that has been absorbed by the clamp. In addition, this reverse current can also be used to achieve soft switching in main switch Q1. These two factors dictate the on time of Q3 and the amount of reverse current that is required to build.

For higher input voltages Vin, the reverse current required to soft switch Q1 increases. Hence, reverse circulating switch Q3 needs to turn on for duration proportional to input voltage. When output voltage is lower, the reflected clamp voltage is also lower, and it takes a longer time to build the same reverse current. Hence, reverse circulating Q3 needs to turn on for duration inversely proportional to output voltage. Additionally, for transformers with higher leakage inductance, the reverse current required might be somewhat greater than that required to achieve soft switching because of the necessity to recycle leakage energy.

In any case, after sufficient reverse current is generated, the reverse current then must cycle through voltage clamp switch Q2 and diode D5 until a new switching cycle starts. This can be referred to as a freewheeling period corresponding to time interval D. Because of the resistance of voltage clamp switch Q2 and the forward voltage drop of diode D5, energy is dissipated during this time interval D. When the input voltage is higher, these losses can be substantial because of the higher reverse current requirement. Furthermore, when the converter operates in deep discontinuous mode (i.e., under lighter load conditions) time interval D may be significantly longer, resulting in more energy loss in voltage clamp switch Q2 and diode D5.

Thus, in at least some applications, light load efficiency requirements may mean that the above-described losses make use of a circuit that operates as described in the ’472 patent undesirable or impractical. However, the following description can address such issues by limiting the current that flows through voltage clamp switch Q2 and diode D5.

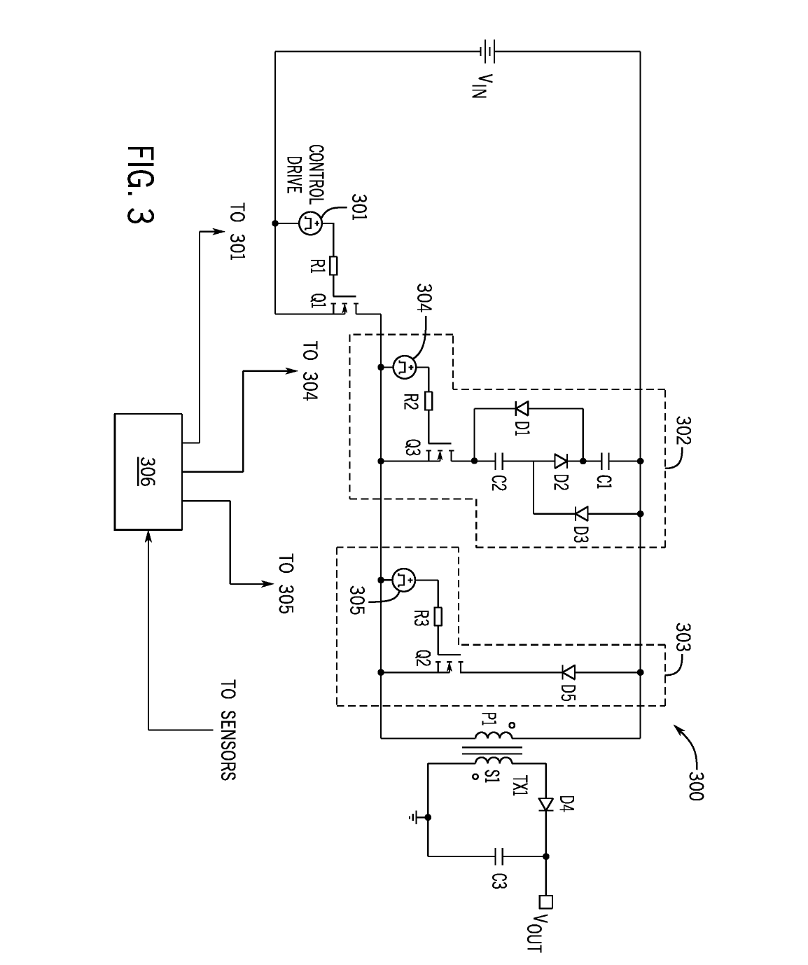

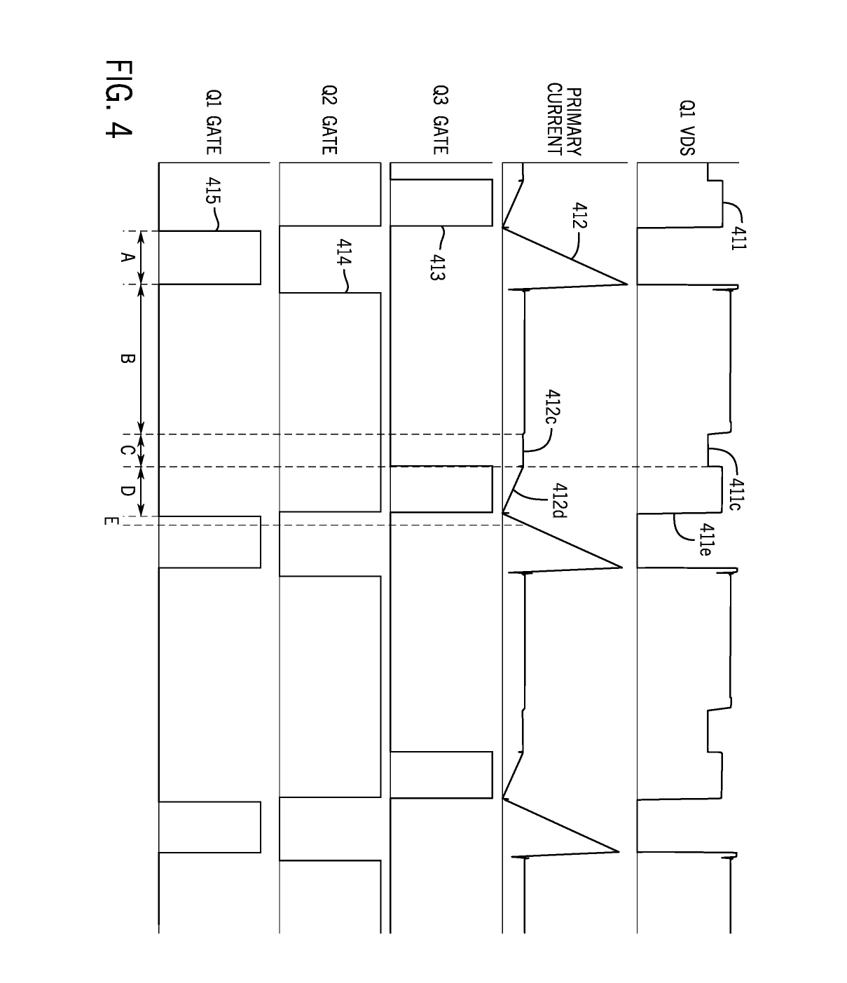

FIG. 3 illustrates a schematic diagram of an improved series-parallel active clamp flyback converter 300 that can operate with an improved switching sequence to reduce losses under conditions such as those described above. Converter 300 is topologically the same as converter 101 discussed above and includes corresponding components labeled with like reference numbers that function as described above with reference to FIGS. 1 and 2, except that the switching sequence can be adapted as described below and illustrated in FIG. 4 to reduce the circulating current flowing through voltage clamp switch Q2 and diode D5. Thus, flyback converter 300 includes the above-described flyback converter components, together with reverse current control circuit 302 and voltage clamp circuit 303, which can operate similarly to circuits 102 and 103 described above with reference to FIG. 1.

FIG. 3 also illustrates control circuitry 306 that can operate converter 300 and its associated switching devices as described herein. Control circuitry 306 can include any suitable combination of analog control circuitry (such as error amplifiers, control loops, etc.), digital control circuitry (logic gates, flip flops, analog-to-digital and/or digital-to-analog converters, etc.), and/or programmable circuitry (microcontrollers, microprocessors, etc.) as desired to implement the control functionality described herein. Control circuitry 306 can have outputs that provide drive signals to the respective driver circuits 301, 304, 305 for the respective switching devices, i.e., main switch Q1, reverse current control switch 304, and voltage clamp switch Q2. Control circuitry 306 can have one or more inputs that receive signals from various voltage, current, and/or other sensors to facilitate operation of the control circuitry to produce the desired switching signals. Such signals may sense one or more circuit parameters such as input voltage, input current, primary coil current, output voltage, output current, etc., and provide such indications to the control circuitry 306. Control circuitry 306 can process these inputs from the various sensors to generate the required switching signals for the various switching devices according to a desired control strategy implemented by control circuitry 306.

FIG. 4 illustrates various waveforms corresponding to an improved switching sequence for a series-parallel active clamp flyback converter. The waveforms of FIG. 4 and associated time intervals generally correspond to those discussed above with respect to FIG. 2 and are labeled with like reference numbers, except that the switching sequence can be adapted as described below to reduce the circulating current flowing through voltage clamp switch Q2 and diode D5. Thus, Curve 411 depicts the drain to source voltage across main switch Q1. Curve 412 depicts the primary current flowing through the primary winding of the flyback transformer. Curve 413 depicts the gate drive signal provided to snubber/reverse current switch Q3. Curve 414 depicts the gate drive signal provided to reverse circulating/voltage clamp switch Q2. Curve 415 depicts the gate drive signal provided to main switch Q1.

The changes to the switching sequence, and thus the modified operation, can be seen in FIG. 4 as follows. During time interval A, the gate drive of main switch Q1 (i.e., Q1_Vgs/curve 411) is high. During this time, the primary current (curve 412) can be seen to ramp up in positive direction. During this period, energy is stored in the flyback transformer. Time interval B begins when main switch Q1 is turned off. Thus, Q1_Vgs (curve 415) goes low, and primary current 412 starts to fall at a rate dictated by leakage inductance. During this time, the energy is transferring to the secondary side. After a short delay, voltage clamp switch Q2 is turned on, corresponding to Q2_Vgs (curve 414) transitioning high, while reverse current control switch Q3 remains off. Voltage clamp switch Q2 is thus switched complementarily to main switch Q1. Also, during time interval B, energy is being delivered to the output of the converter. Finally, during time interval B, there is no current flowing through voltage clamp switch Q2 and diode D5.

Time interval C can begin when the energy stored in the flyback transformer has completely depleted, i.e., delivered to a load connected to the output of the converter. At the beginning of time interval C, the primary winding voltage is clamped by voltage clamp switch Q2 and diode D5. This can be seen in a dip 411cin the voltage across main switch Q1. During this time the primary winding voltage is held nearly at zero voltage, and very small currents flow through voltage clamp switch Q2 and diode D5. These small currents correspond to primary current curve segment 412c and are a function of parasitic capacitance and reverse recovery phenomenon.

Time interval D is marked by reverse current control switch Q3 turning on, depicted by curve 413 transitioning high. This allows primary winding current to build up in the reverse direction, as indicated by primary winding curve segment 412d. Thereafter, time interval E begins when reverse current control switch Q3 and voltage clamp switch Q2 are turned off simultaneously, as depicted in curves 413 and 414. As a result, the voltage appearing at drain node of Q1 falls towards zero, as depicted by curve segment 411e. During time interval E, leakage energy is recovered to the input and parasitic capacitances as the snubber capacitors discharge in a substantially loss-less resonant manner.

A difference between the switching sequence described with reference to FIG. 4 and the prior art switching sequence described above with reference to FIG. 2 lies in the switching timing of reverse current control switch Q3. In the ’472 patent, reverse current control switch Q3 is turned on shortly after time interval A (and substantially contemporaneously with the turn on of voltage clamp switch Q2) and is turned off after sufficient reverse current is built during time interval C. In other words, in the ’472 patent, both reverse current control switch Q3 and voltage clamp switch Q2 are switched complimentarily to main switch Q1. Then this reverse current, which can be relatively large, must circulate through voltage clamp switch Q2 and diode D5 until the flyback transformer discharge period expires. Conversely, in the modified switching scheme described herein, reverse current control switch Q3 is turned on just before flyback period expires, rather than as it begins, and thus is not complementary to switching of main switch Q1. In other words, at the beginning of the flyback period, voltage clamp switch Q2 is turned on (complementarily to main switch Q1), and then—after a delay and near the end of the flyback period, the reverse current control switch Q3 is turned on. This delay in turning on the reverse current control switch (which is implemented by control circuitry 306) reduces the reverse current buildup during time interval C, which can be seen by comparing curve segment 412c or FIG. 4 to curve segment 212c of FIG. 2. Because no large reverse current circulates through voltage clamp switch Q2 and diode D5, operating efficiency can be improved when the converter is in deep discontinuous mode (i.e., lightly loaded) or when other operating condition would otherwise result in reverse currents.

To summarize the operation described above, control circuitry 306 (FIG. 3) can operate the switching devices of the flyback converter as follows: (1) During an initial time period A, control circuitry 306 can turn on main switch Q1 to store energy in the flyback transformer (e.g., in a leakage inductance of a primary winding). (2) During a subsequent time period B, control circuitry 306 can turn off main switch Q1 and, after a short delay, control circuitry 306 can turn on voltage clamp switch with reverse current switch Q3 remaining off. During time period B, energy stored in the flyback converter can begin being delivered to a load connected to the output of the converter. (3) When the energy in the transformer is depleted, time period C begins, during which the primary winding voltage of the flyback converter will be clamped by voltage clamp switch Q2, which remains on, and only a small current flows through the voltage clamp. (4) Thereafter, i.e., after energy in the transformer has been depleted and following a period during which there is only a small current flowing through the voltage clamp switch, time period D begins when control circuitry 306 turns on the reverse current control switch Q3 while voltage clamp switch remains on. This can allow a reverse current to build in the primary winding. (5) Once the reverse current has built to a sufficient level, control circuitry 306 can turn off reverse current switch Q3 and voltage clamp switch Q2 simultaneously, beginning time period E during which leakage energy is recovered by discharging the snubber capacitors. The cycle can then repeat at a fixed frequency, with control circuitry 306 controlling the duty cycle of the main switch to regulate the output of the converter.

With the proposed switching arrangement, voltage clamp switch and Q2 and diode D5 will still have some parasitic currents flowing, but these can be substantially smaller than the intentional reverse current generated by reverse current control switch Q3 to recycle leakage energy and achieve soft switching.

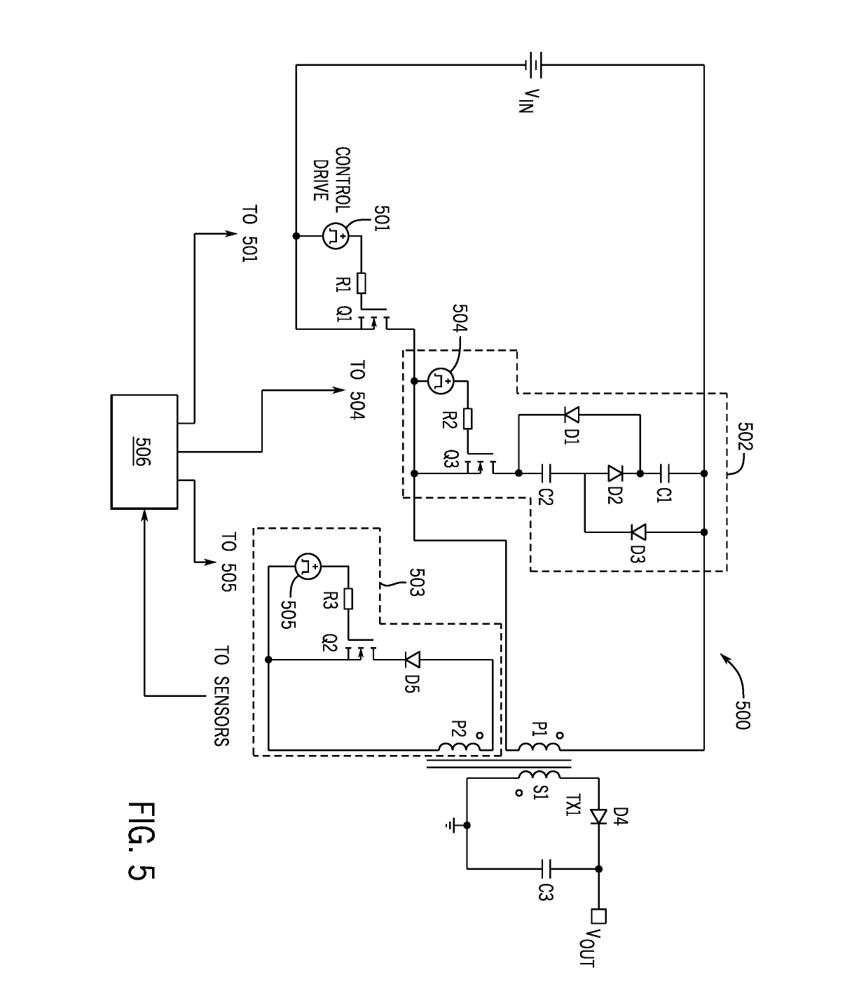

FIG. 5 illustrates a schematic diagram of an alternative configuration of an improved series-parallel active clamp flyback converter 500 with a voltage clamp connected to an auxiliary winding. Converter 500 is topologically similar to converters 101 and 301 discussed above and includes corresponding components labeled with like reference numbers that function as described above with reference to FIGS. 1–4 (with the switching sequence as described with reference to FIGS. 3–4), except that voltage clamp circuit including voltage clamp switch Q2 and diode D5 is connected to an auxiliary winding P2 of the flyback transformer. Thus, flyback converter 500 includes the above-described flyback converter components, together with reverse current control circuit 502 and voltage clamp circuit 503, which can operate similarly to circuits 302 and 303 described above with reference to FIG. 3.

Because voltage clamp switch Q2 and diode D5 no longer need to conduct large currents, due to the switching sequence described with reference to FIG. 4, the voltage clamping action provided by voltage clamp switch Q2 and diode D5 can be achieved by moving them to an auxiliary winding of the flyback transformer. This can result in various advantages. For example, voltage clamp switch Q2 can be driven without the use of high voltage gate driver, which can simplify the circuit complexity. Moreover, if the number of turns of auxiliary winding P2 is less than the number of turns of primary winding P1, voltage clamp switch Q2 and diode D5 can potentially have a lower voltage than would otherwise be required, which in turn can potentially save component space and reduce the cost of these components.

FIG. 5 also illustrates control circuitry 506 that can operate converter 500 and its associated switching devices as described herein. Like control circuitry 306, control circuitry 506 can include any suitable combination of analog control circuitry (such as error amplifiers, control loops, etc.), digital control circuitry (logic gates, flip flops, analog-to-digital and/or digital-to-analog converters, etc.), and/or programmable circuitry (microcontrollers, microprocessors, etc.) as desired to implement the control functionality described herein. Control circuitry 506 can have outputs that provide drive signals to the respective driver circuits 501, 504, 505 for the respective switching devices, i.e., main switch Q1, reverse current control switch 504, and voltage clamp switch Q2. Control circuitry 506 can have one or more inputs that receive signals from various voltage, current, and/or other sensors to facilitate operation of the control circuitry to produce the desired switching signals. Such signals may sense one or more circuit parameters such as input voltage, input current, primary coil current, output voltage, output current, etc., and provide such indications to the control circuitry 506. Control circuitry 506 can process these inputs from the various sensors to generate the required switching signals for the various switching devices according to a desired control strategy implemented by control circuitry 506.

To summarize the operation, control circuitry 506 can operate the switching devices of the flyback converter as follows: (1) During an initial time period A, control circuitry 506 can turn on main switch Q1 to store energy in the flyback transformer (e.g., in a magnetizing inductance of a primary winding). (2) During a subsequent time period B, control circuitry 506 can turn off main switch Q1 and, after a short delay, control circuitry 506 can turn on voltage clamp switch with reverse current switch Q3 remaining off. During time period B, energy stored in the flyback converter can begin being delivered to a load connected to the output of the converter. (3) When the energy in the transformer is depleted, time period C begins, during which the primary winding voltage of the flyback converter will be clamped by voltage clamp switch Q2, which remains on, and only a small current flows through the voltage clamp. (4) Thereafter, i.e., after energy in the transformer has been depleted and following a period during which there is only a small current flowing through the voltage clamp switch, time period D begins when control circuitry 506 turns on the reverse current control switch Q3 while voltage clamp switch remains on. This can allow a reverse current to build in the primary winding. (5) Once the reverse current has built to a sufficient level, control circuitry 506 can turn off reverse current switch Q3 and voltage clamp switch Q2 simultaneously, beginning time period E during which leakage energy is recovered in a resonant manner. The cycle can then repeat at a fixed frequency, with control circuitry 506 controlling the duty cycle of the main switch to regulate the output of the converter.

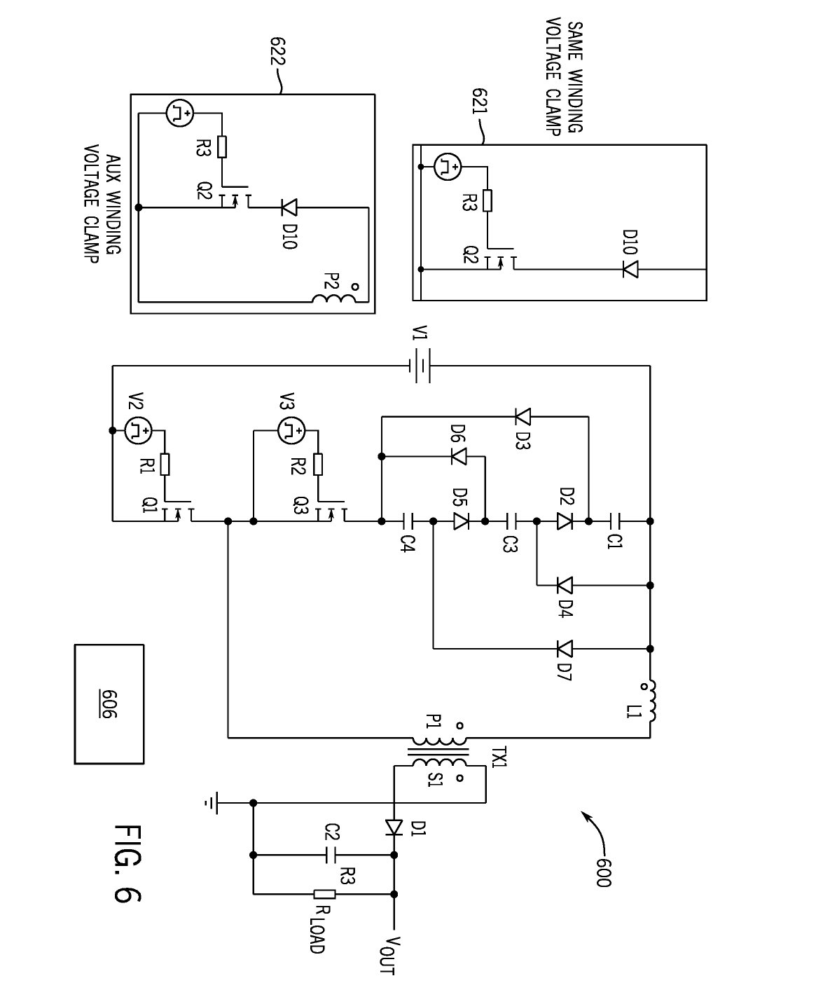

The above-described improvements to operation of a flyback converter with a series parallel active clamp can be applied to variations of such flyback converters as described below with respect to FIGS. 6–8. Similar flyback converter topologies are described in Applicant’s issued ’270 patent incorporated by reference above.

For example, FIG. 6 illustrates a variation of a series-parallel mode active clamp flyback converter using additional snubber capacitors. More specifically, the embodiments discussed above use a snubber clamp comprising two capacitors and three diodes. The two snubber capacitors charge in series and discharge in parallel. The core concept of the series-parallel mode active clamp circuit may be extended by the use of ‘n’ number of snubber capacitors, along with a corresponding number of diodes to achieve all the benefits. For example, as shown in converter circuit 600 of FIG. 6, additional snubber capacitor C4 and diodes D5, D6, and D7 are utilized in the circuit. In particular, additional capacitor C4 is connected in series with snubber capacitors C1 and C3, in between C3 and reverse current control switch Q3. As shown in FIG. 6, additional diode D5 is connected in series between C3 and C4; additional diode D6 is connected in parallel across C4 and D5; and additional diode D7 is connected in parallel across C1, C3, D2, and D5. The arrangement of three snubber capacitors shown in FIG. 6 results in all three capacitors charging in series and discharging in parallel. The same principle may be extended to any number “n” of capacitors when used with the appropriate diodes, as shown in FIG. 6.

In accordance with the principles described above with reference to FIGS. 3–5, additional voltage clamp circuitry can be added to the circuit of FIG. 6 to facilitate fixed frequency operation. In some embodiments, voltage clamp circuitry 621 (corresponding to voltage clamp circuitry 103/303) can be coupled to converter 600, for example by coupling the anode of diode D10 (corresponding to diode D5 in FIGS. 3 and 5) to the anode of diode D7 and a first terminal of the primary winding and coupling the drain of voltage clamp switch Q2 (and optionally the “ground” or reference terminal of its driver circuit to the source of main switch Q1. Alternatively, voltage clamp circuitry 622 (corresponding to voltage clamp circuitry 503) can be coupled to converter 600 by an auxiliary winding P2 provided with flyback converter TX1.

FIG. 6 also illustrates control circuitry 606, which can operate as described above with respect to control circuitry 306/506.

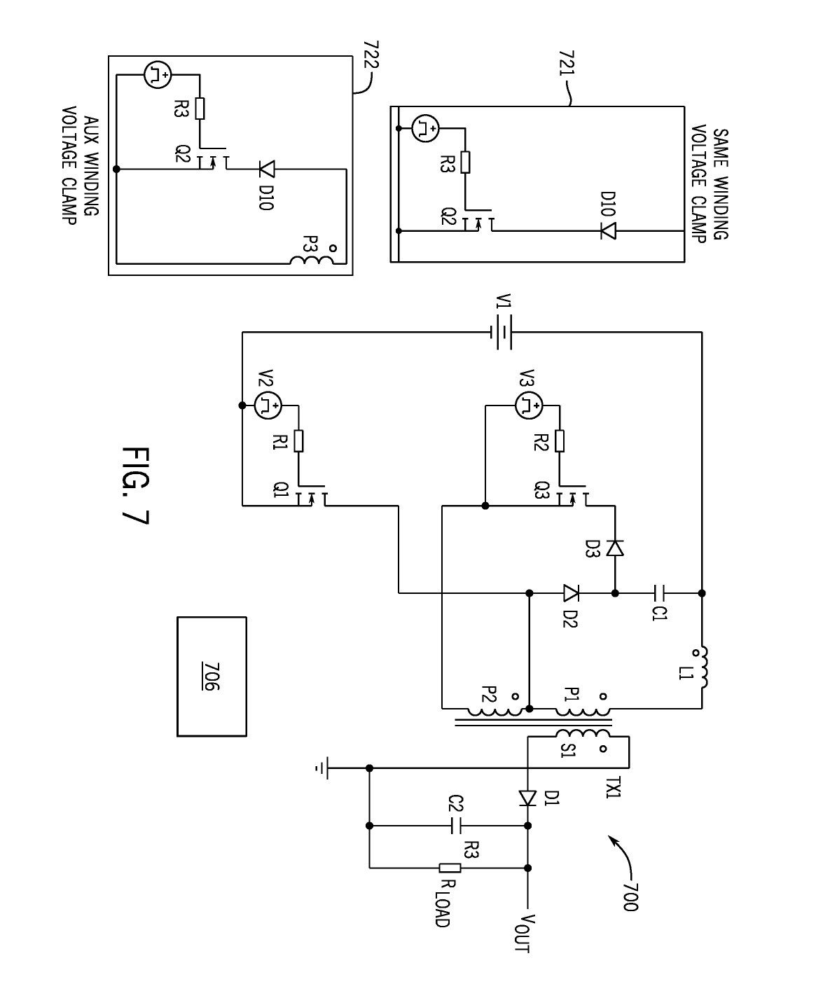

FIG. 7 illustrates an alternate embodiment of a series-parallel mode active clamp flyback converter using a high side auxiliary winding. According to the embodiment shown in converter circuit 700 of FIG. 7, the second snubber capacitor, C3, and diode D4 are removed from the circuit of FIG. 2. In their place, the diode D2 is instead connected between the primary winding P1 and auxiliary primary winding P2 of the transformer TX1, as well as to main switch Q1 (rather than clamp switch Q2). According to the operation of the circuit 700 shown in FIG. 9, the energy from the leakage inductance is transferred to the snubber capacitor C1 at the turn off transition through D2. This energy does not transfer back into the transformer, as the diode D3 is reverse biased due to much higher reflected voltage at its cathode node impressed by auxiliary winding. If the two primary windings P1 and P2 have equal turns, and if the reflected voltage across primary P1 is 80V (as but one example), then the reflected voltage at the source node of clamp switch Q2 would be 160V with respect to Vin. Thus, the current from the snubber capacitor C1 does not transfer energy through clamp switch Q2. When the transformer energy is discharged, and it starts to resonate with the equivalent capacitance at the drain node of main switch Q1, energy transfer starts in a manner similar to that described above, i.e., through D3 and Q2. The turns ratio of the primary and auxiliary winding may be varied during circuit optimization.

In accordance with the principles described above with reference to FIGS. 3–5, additional voltage clamp circuitry can be added to the circuit of FIG. 7 to facilitate fixed frequency operation. In some embodiments, voltage clamp circuitry 721 (corresponding to voltage clamp circuitry 103/303) can be coupled to converter 700, for example by coupling the anode of diode D10 (corresponding to diode D5 in FIGS. 3 and 5) to the junction of snubber capacitor C1 and a first terminal of primary winding P1 (note intervening leakage inductance L1, which is not necessarily a real component, but may be a property of primary winding P1) and coupling the drain of voltage clamp switch Q2 (and optionally the “ground” or reference terminal of its driver circuit to the source to the drain of switch Q3. Alternatively, voltage clamp circuitry 722 (corresponding to voltage clamp circuitry 503) can be coupled to converter 800 by a further auxiliary winding P3 provided with flyback converter TX1.

FIG. 7 also illustrates control circuitry 706, which can operate as described above with respect to control circuitry 306/506.

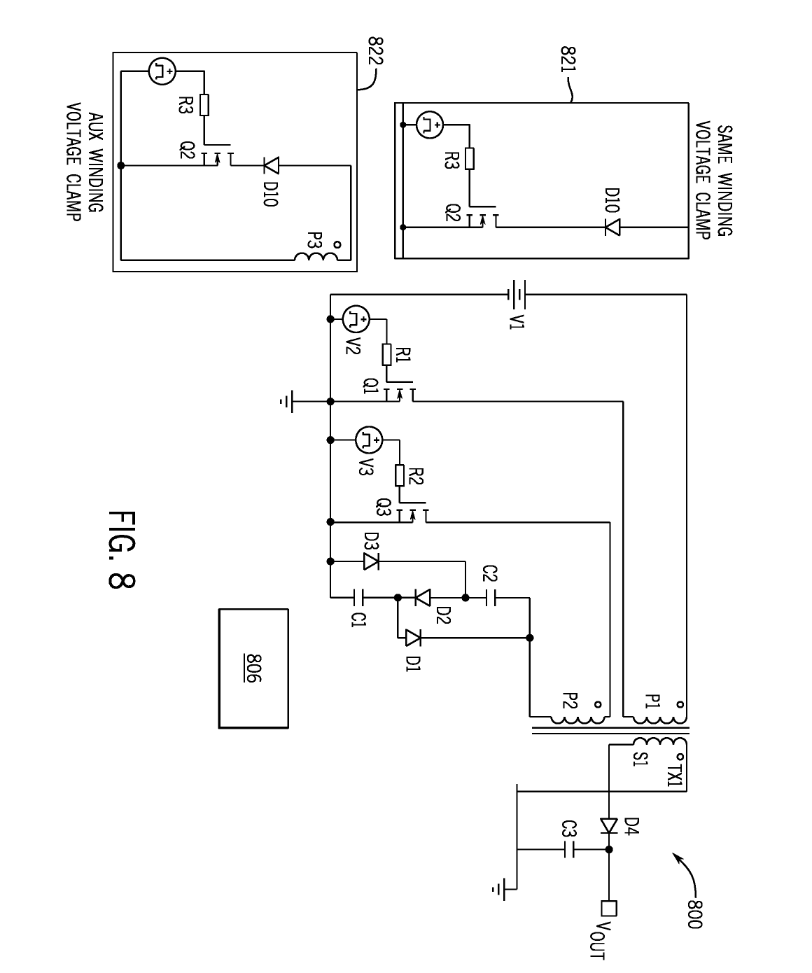

FIG. 8 illustrates an alternate embodiment of a series-parallel mode active clamp flyback converter using a reflected clamp. According to the embodiment shown in converter circuit 800 of FIG. 8, a low side auxiliary winding P2 is used to achieve the same purpose as the series-parallel mode active clamp circuit discussed above with respect to FIG. 7. According to the embodiment shown in FIG. 8, the main switch Q1 is connected to the high side of primary winding P1, and reverse current control switch Q3 is connected to the low side of auxiliary primary winding, P2. The reflected clamp comprises snubber capacitor C1, diode D2, and snubber capacitor C2 connected in series; diode D1 connected in parallel across C2 and D2; and diode D3 connected in parallel across C1 and D2. The output diode and output capacitor are relabeled D4 and C3, respectively. The low-side auxiliary winding, P2, may have same number of turns as the primary winding, P1, or a different number. Although the diodes in FIG. 8 are shown as Schottky diodes, such a choice is not strictly necessary, and any suitable diode may be selected for a given implementation. In some embodiments, synchronous rectification may also be used.

There are at least two aspects of the alternative embodiment shown in circuit 800 worth noting. The first is the recovery of leakage inductance energy, and the second is zero voltage switching of the main switch Q1. This alternate embodiment shown in circuit 800 achieves the second aspect of ZVS, although the extent of leakage energy recovery depends upon the coupling between the primary winding P1 and the auxiliary winding P2. If the leakage is zero, then it may achieve the same performance as the other embodiments above, but such zero leakage is not practical. If auxiliary windings P1 and P2 use the same number of turns and are wound in a bifilar fashion, then the leakage is the lowest, and a significant amount of leakage energy can be recovered. One advantage of the embodiment described with reference to FIG. 8 is the simplicity of use, owing to the fact that the drive for the reverse current control switch Q3 is positioned low side and thus easier to implement through an integrated controller. This may also reduce the overall cost of the control circuit.

In accordance with the principles described above with reference to FIGS. 3–5, additional voltage clamp circuitry can be added to the circuit of FIG. 8 to facilitate fixed frequency operation. In some embodiments, voltage clamp circuitry 821 (corresponding to voltage clamp circuitry 103/303) can be coupled to converter 800, for example by coupling the anode of diode D10 (corresponding to diode D5 in FIGS. 3 and 5) to the junction of snubber capacitor C2 and the cathode of diode D1 and coupling the drain of voltage clamp switch Q2 (and optionally the “ground” or reference terminal of its driver circuit to the ground rail illustrated in FIG. 8. Alternatively, voltage clamp circuitry 822 (corresponding to voltage clamp circuitry 503) can be coupled to converter 800 by a further auxiliary winding P3 provided with flyback converter TX1.

FIG. 8 also illustrates control circuitry 806, which can operate as described above with respect to control circuitry 306/506.

The foregoing describes exemplary embodiments of flyback converters that can operate with improved efficiency. Such configurations may be used in a variety of applications but may be particularly advantageous when used in conjunction power supplies for personal electronic devices, computing devices, etc. Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. A flyback converter comprising:
flyback converter circuitry including a flyback transformer having a primary winding coupled to a secondary winding and a main switch that alternately turns on to store energy from an input coupled to the primary winding in the flyback transformer and turns off deliver energy from the flyback transformer to an output coupled to the secondary winding;
a voltage clamp circuit coupled to the flyback transformer, the voltage clamp circuit including a diode and a voltage clamp switch, wherein the voltage clamp switch operates complementarily to the main switch;
a reverse current circuit coupled to the flyback transformer, the reverse current circuit including one or more snubber capacitors, one or more diodes, and a reverse current control switch, wherein the reverse current control switch operates in conjunction with the voltage clamp switch to recover leakage energy from the flyback converter circuitry; and
control circuitry that provides drive signals to the main switch, voltage clamp switch, and reverse current control switch such that:
the main switch operates at a fixed frequency and the control circuitry varies a duty cycle of the main switch to regulate an output voltage delivered to the output;
the voltage clamp switch operates complementarily to the main switch; and
the reverse current control switch turns on after energy stored in the flyback transformer is delivered to the output and a voltage of the primary winding is clamped by the voltage clamp circuit and turns off with the voltage clamp switch.

2. The flyback converter of claim 1 wherein the voltage clamp circuit is electrically coupled to the flyback transformer.

3. The flyback converter of claim 2 wherein the voltage clamp circuit is electrically coupled in parallel with the primary winding.

4. The flyback converter of claim 3 wherein:
the one or more snubber capacitors include a plurality of snubber capacitors;
the one or more diodes include a plurality of diodes; and
the reverse current circuit recovers leakage energy from the flyback converter circuitry by charging the snubber capacitors in series and discharging the snubber capacitors in parallel.

5. The flyback converter of claim 4 wherein the reverse current circuit comprises three or more snubber capacitors and six or more diodes.

6. The flyback converter of claim 2 wherein the voltage clamp circuit is magnetically coupled to the flyback transformer by an auxiliary winding to reduce current in the voltage clamp circuit.

7. The flyback converter of claim 6 wherein:
the one or more snubber capacitors include a plurality of snubber capacitors;
the one or more diodes include a plurality of diodes; and
the reverse current circuit recovers leakage energy from the flyback converter circuitry by charging the snubber capacitors in series and discharging the snubber capacitors in parallel.

8. The flyback converter of claim 7 wherein the reverse current circuit comprises three or more snubber capacitors and six or more diodes.

9. A method of operating a plurality of switching devices of a flyback converter, the method being performed by control circuitry of the flyback converter and comprising:
operating a main switch at a fixed frequency to alternately store energy in a flyback transformer when the main switch is turned on and deliver energy from the flyback transformer to an output when the main switch is turned off;
operating a voltage clamp switch complementarily to the main switch to clamp a voltage across a primary winding of the flyback transformer while the flyback converter is delivering energy to the output; and
operating a reverse current switch to recover leakage energy in the flyback converter by turning on the reverse current switch while the voltage clamp switch is turned on and after energy stored in the flyback transformer is delivered to the output and turning off the reverse current switch with turning off with the voltage clamp switch.

10. The method of claim 9 further comprising varying a duty cycle of the main switch to regulate an output voltage delivered to the output.

11. The method of claim 9 wherein turning on the reverse current switch charges one or more snubber capacitors of a reverse current circuit and turning off the reverse current switch discharges the one or more snubber capacitors, thereby recovering leakage energy in the flyback converter.

12. The method of claim 11 wherein turning on the reverse current switch charges a plurality snubber capacitors of the reverse current circuit in series and turning off the reverse current switch discharges the plurality snubber capacitors in parallel, thereby recovering leakage energy in the flyback converter.

13. A flyback converter comprising:
flyback converter circuitry including a flyback transformer and a main switch;
a voltage clamp circuit coupled to the flyback transformer and including a voltage clamp switch that operates complementarily to the main switch;
a reverse current circuit coupled to the flyback transformer, the reverse current circuit including at least one snubber capacitor and a reverse current control switch, wherein the reverse current control switch operates in conjunction with the voltage clamp switch to recover leakage energy from the flyback converter circuitry; and
control circuitry that provides drive signals to the main switch, voltage clamp switch, and reverse current control switch so as to:
operate the main switch to alternately store energy in the flyback transformer when the main switch is turned on and deliver energy from the flyback transformer to an output when the main switch is turned off;
operate the voltage clamp switch complementarily to the main switch to clamp a voltage across a primary winding of the flyback transformer while the flyback converter is delivering energy to the output; and
operate the reverse current control switch to recover leakage energy in the flyback converter by turning on the reverse current control switch while the voltage clamp switch is turned on and after energy stored in the flyback transformer is delivered to the output and turning off the reverse current control switch with turning off with the voltage clamp switch.

14. The flyback converter of claim 13 wherein the control circuitry operates the main switch at a fixed frequency.

15. The flyback converter of claim 14 wherein the control circuitry varies a duty cycle of the main switch to regulate an output voltage delivered to the output.

16. The flyback converter of claim 13 wherein the voltage clamp circuit is electrically coupled to the flyback transformer.

17. The flyback converter of claim 16 wherein the voltage clamp circuit is coupled in parallel with the primary winding of the flyback transformer.

18. The flyback converter of claim 16 wherein the reverse current circuit includes a plurality of snubber capacitors and a plurality of diodes and recovers leakage energy from the flyback converter circuitry by charging the snubber capacitors in series and discharging the snubber capacitors in parallel.

19. The flyback converter of claim 13 wherein the voltage clamp circuit is magnetically coupled to the flyback transformer by an auxiliary winding to reduce current in the voltage clamp circuit.

20. The flyback converter of claim 13 wherein the reverse current circuit includes a plurality of snubber capacitors and a plurality of diodes and recovers leakage energy from the flyback converter circuitry by charging the snubber capacitors in series and discharging the snubber capacitors in parallel.
